(19) United States
(12) Patent Application Publication
(10) Pub. No.: US 2008/0082684 A1
(43) Pub. Date: Apr. 3, 2008

(54) COMPUTER IMPLEMENTED METHOD AND APPARATUS FOR CONTENT CONVERSION, ROUTING AND EXECUTION

(76) Inventors: Maria Gaos, Seattle, WA (US); Nazih Youssef, Bothell, WA (US)

Correspondence Address: AXIOS LAW GROUP. PLLC, 1525 FOURTH AVENUE, SUITE 800, SEATTLE, WA, 98101, US

(21) Appl. No.: 11/537,528

(22) Filed: Sep. 29, 2006

(51) Int. Cl. G06F 15/173

(52) U.S. Cl. 709/238; 709/231

(57) ABSTRACT

A computer-implemented method for converting and routing content over a network, the content having at least one portion, the method comprising receiving the at least one portion of content over the network, verifying whether the at least one portion of content was previously stored and converted for execution on one or more client devices, converting the at least one portion of content on at least one server if it has not been previously stored and converted for execution on the client devices, retrieving the at least one portion of content on the at least one server if it has been previously stored and converted for execution on the client devices, routing the content over the network to the client devices, and executing the retrieved and/or converted content on the client devices.

### FIELD

The present disclosure relates generally to data processing and communications and, in particular but not exclusively, relates to a method and apparatus for content conversion, distribution and execution on computing devices.

### BACKGROUND

The dramatic emergence of the Internet as a medium for commerce and the myriad computing devices such as new and faster personal computers, portable computers, pocket computers, mobile hand-held devices and various Internet-enabled appliances has provided end-users of these devices with unique opportunities to send and receive different forms of content in a number of different formats. Given the rapid pace of worldwide access to the Internet and to other networks coupled to the Internet such as intranets and extranets, an ever-increasing number of consumer devices will be capable of sending and receiving content of many different types in many different formats. Although new standards have been created to provide for more efficient transmission protocols and content formats, it is still challenging to convert content rapidly and efficiently for execution on an unlimited number of consumer devices. This challenge is made all the greater when the content is in completely dissimilar formats and the conversion of the content must be accomplished in a timely way while also ensuring that the converted result can be effectively and efficiently routed to consumer devices coupled to a diverse array of networks.

The constantly evolving use of new and different types of devices also gives rise to an increasing need for a “mobile network” that can provide service comparable to that available from standard wired service regardless of whether such service is provided though a telephone network, a high speed cable modem or a digital subscriber line. Although the standardization of different transmission protocols enables manufacturers to build consumer electronic devices that are capable of receiving and sending content in new formats, the ability to universally adapt content to devices rather than producing a plethora of devices for content by the incorporation of new interfaces and device drivers remains an elusive goal and a perplexing technical challenge.

Thus, there is a need for a method, product and apparatus that will enable dynamic, universal content conversion in one integrated fashion for the execution of content on consumer devices that is delivered over networks comprised of processing devices which are selectively enabled to receive, execute and control such content.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a data processing and communications system comprised of multiple content sources, data processing servers, client devices and a network in an embodiment.

FIG. 2 is a block diagram illustrating a client device in an embodiment.

FIG. 3 is a block diagram illustrating a data processing server in an embodiment.

FIG. 4 is a block diagram illustrating a content conversion and distribution product in an embodiment.

FIG. 5 is a block diagram illustrating a content execution product in an embodiment.

FIG. 6A is a flow chart illustrating a computer-implemented method for content execution and routing in an embodiment.

FIG. 6B is a flow chart illustrating a method for verifying the compatibility of received content for execution on a client device in an embodiment.

FIG. 6C is a flow chart illustrating a method for verifying the compatibility of received content for execution on a client device in an alternative embodiment.

### DETAILED DESCRIPTION

In the description to follow, various aspects of embodiments will be described, and specific configurations will be set forth. These embodiments, however, may be practiced with only some or all aspects, and/or without some or all of these specific details. In other instances, well-known features are omitted or simplified in order not to obscure important aspects of the embodiments.

The description will be presented in terms of operations performed by a processor based device consistent with the manner commonly employed by those skilled in the art to convey the substance of their work to others skilled in the art. As is well understood by those skilled in the art, the quantities take the form of electrical, magnetic, electromagnetic or optical signals capable of being stored, transferred, combined and otherwise manipulated through mechanical, electrical and/or optical components of the processor based device.

Various operations will be described as multiple discrete steps in turn, in a manner that is most helpful in understanding each disclosed embodiment; however, the order of description should not be construed as to imply that these operations are necessarily order dependent. In particular, these operations need not be performed in the order of presentation.

The description repeatedly uses the phrases “in one embodiment”, which ordinarily does not refer to the same embodiment, although it may. The terms “comprising,” “including,” “having,” and the like, as used in the present disclosure, are synonymous.

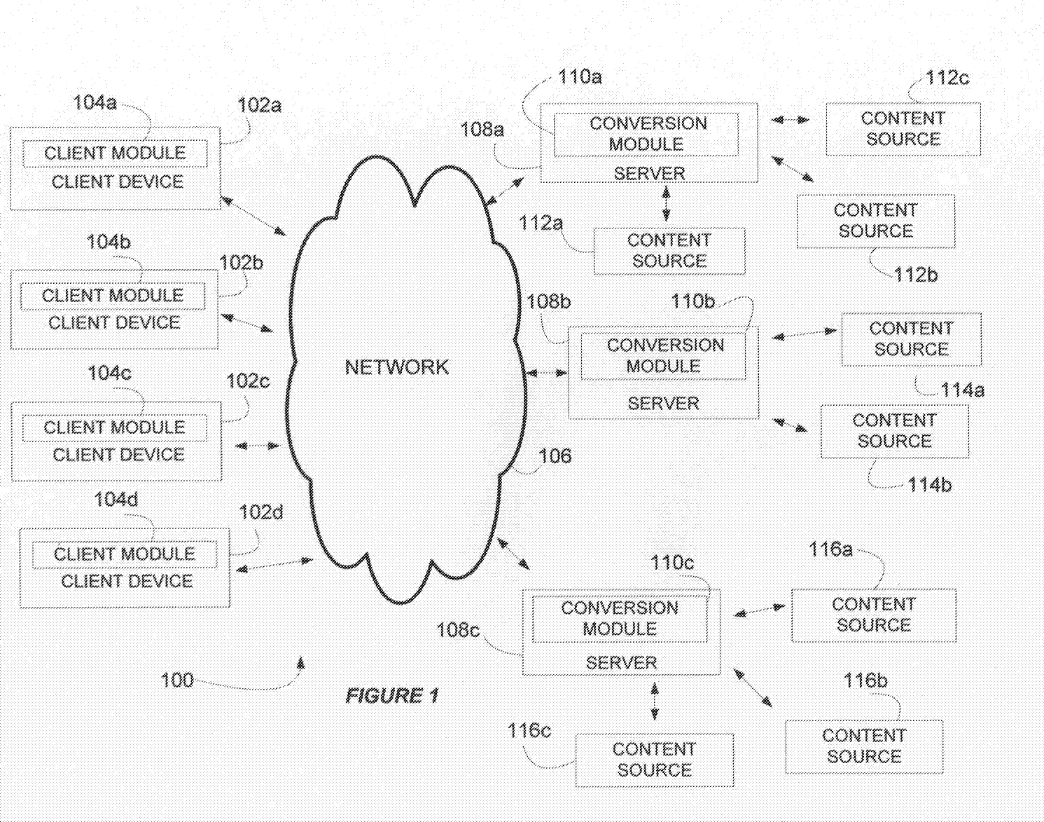

FIG. 1 illustrates a system 100 comprised of a plurality of content sources 112a-112c, 114a and 114b, and 116a-116c, and a plurality of data processing servers 108. Each of the data processing servers 108a-108c are coupled to a network 106 and are used for sending and receiving communications to and from each of the client devices 102a-102d. Each content source 112, 114, 116 captures content in a variety of formats and transmission protocols. Among the different types of information that can be captured and formatted by content sources 112, 114, 116 are audio information, image information, video information, text information and multimedia information. Multimedia information in this context is considered to be information that may be a composite of text information, audio information, image information and video information.

Content may be captured in an analog format or a digital format, and such content may be rendered a composite form that is partly in digital format and partly in analog format. Representative examples of content sources 112, 114, 116 include a network of cameras or viewing devices at one or more geographic locations, a television broadcasting camera, a digital camera, a digital camcorder, one or more Internet websites, film rendered in analog or digital format, and textual information received from one or more text sources.

Each content source 112, 114, 116 is in communication with a data processing server 108 allocated to the geographic region of coverage in which a content source 112, 114, 116 has been provided. Each geographic region is not arbitrarily defined but is determined from content transmission traffic patterns, content source usage patterns and the pertinence of the content generated for or by users of the content sources 112, 114, 116. The pertinence of the generated content is determined from a pertinence factor which is a percentage representing the ratio of the number of users to whom the content is pertinent relative to the number of users in a geographic region. In one embodiment, the pertinence factor is greater than 50%. In other embodiments the pertinence factor may be lower and may depend on the nature of the content. As shown in FIG. 1, content sources 112a-112c have been allocated to data processing server 108a. Content sources 114a and 114b have been allocated to data processing server 108b and content sources 116a-116c have been allocated to data processing server 108c. Each content source 112, 114, 116 may be an individual content generator or a collection of networked content sources that generate information data signals for data processing by each data processing server 108.

Each data processing server 108a-108c includes a conversion module 110, which processes the information data signals received from each of the corresponding content sources 112, 114, 116 in a geographical region. After processing and conversion of the information data signals, the converted content will be transmitted and routed over network 106 to one or more of the client devices 102a-102d. Each of the client devices 102a-102d includes a client module 104 that processes and executes the content received from each of the data processing servers 108a-108c. In one embodiment, the majority of communications occurs in a one-way direction from each of the data processing servers 108 to one or more client devices 102a-102d. In an alternative embodiment, the client module 104 on each client device 102a-102d receives a user's language selection that is transmitted to one or more of the data processing servers 108 for execution by one or more of the conversion modules 110. The network 106 may be the Internet, a virtual private network, a satellite network, a corporate intranet or a network of networks comprised of two or more of these networks.

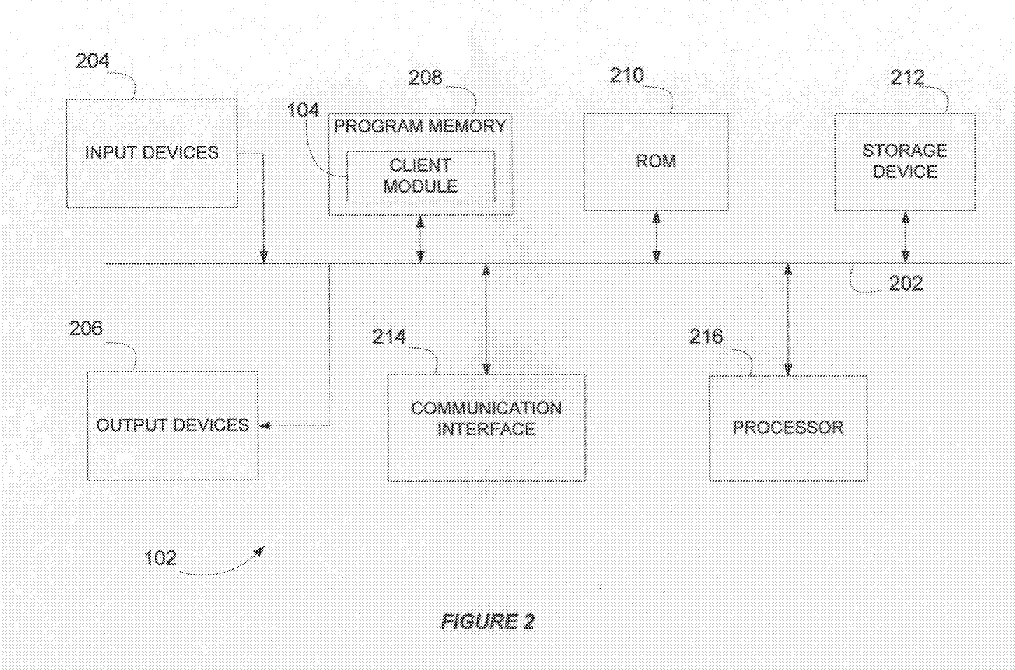

FIG. 2 illustrates an embodiment of a client device 102. As shown, each client device 102 includes a plurality of input devices 204, a plurality of output devices 206, a program memory 208, a read-only memory 210, a storage device 212, a processor 216 having a plurality of operational modes and a communication interface 214. Each of the foregoing devices and components are coupled to a common communication bus 202 to facilitate data processing and communications among each of the components. Client module 104 is stored in the program memory 208 for ready retrieval and execution by the processor 216 of received content.

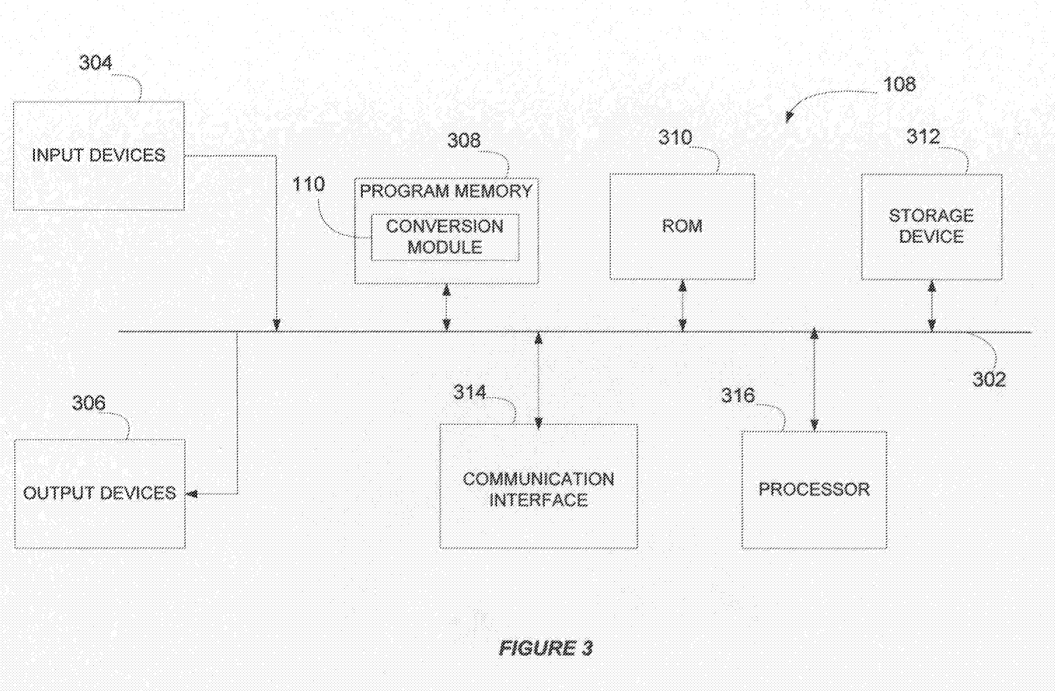

FIG. 3 illustrates an embodiment of a data processing server 108. As is indicated in this figure, each data processing server 108 includes a plurality of input devices 304, a plurality of output devices 306, a program memory 308, a read-only memory 310, a storage device 312, a processor 316, and communication interface 314. Each of the components and devices are coupled to a common communication bus 302 and conversion module 110 is stored in the program memory 308 for execution of content received from one or more content sources 112, 114, 116.

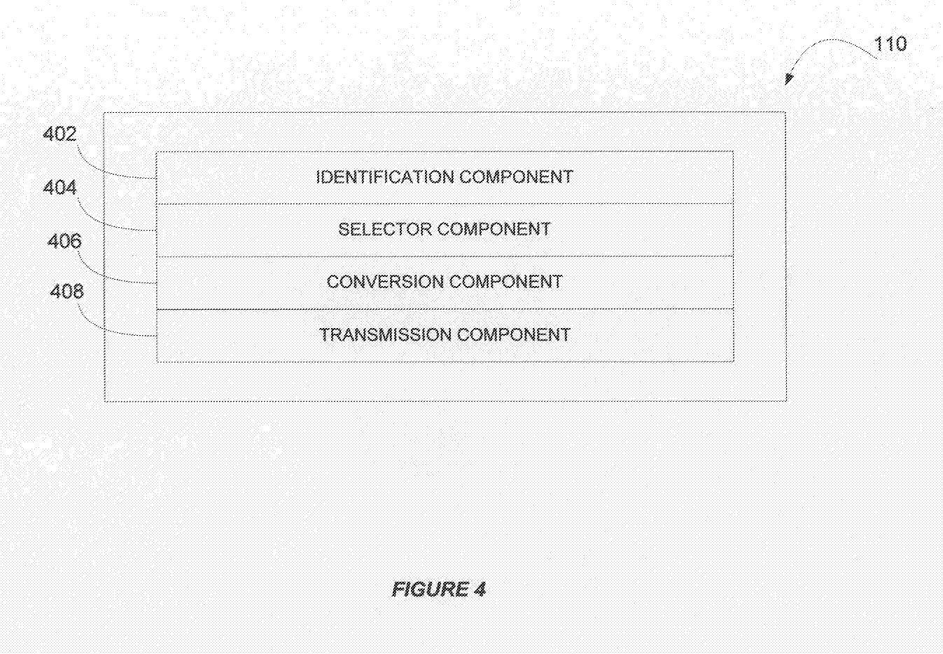

FIG. 4 illustrates an embodiment of the conversion module 110 which includes several components including an identification component 402, a selector component 404, a conversion component 406 and a transmission component 408. In one embodiment of the conversion module 110, a signal attribute component is included in addition to the foregoing listed components. In an alternative embodiment, a validation component is included along with a signal attribute component along with these four identified components. The identification component 402 is operative to determine a format and a transmission protocol of at least one portion of received content from the content sources 112, 114 or 116. The selector component 404 is operative to select a conversion for at least one portion of received content and to select a conversion for the format and transmission protocol of content received from the content sources 112, 114, 116. The selector component 404 is also operative to select a conversion for received content based on the format, the transmission protocol, the semantic content, the language-specific symbolic content, a source signal resolution for a received information data signal, a destination signal resolution for one or more of the client devices 102, a source signal frequency for the information data signal and a destination signal frequency for one or more of the client devices 102. In addition, the selector component 404 is operative to designate a signal for transmission of content to one or more client devices 102 and such signal may be designated for at least a wireless communication channel, a satellite communication channel, a broadcast communication channel or a wired communication channel.

Conversion component 406 is operative to convert at least one portion of content and its format and transmission protocol based on the particular conversion selected by the selector component 404. The selector component 404 is also operative to retrieve a selected conversion for at least one portion of content from a previously selected conversion stored in a memory. Transmission component 408 is operative to transmit and route converted content over a network 106 to one or more of the client devices 102. Transmission component 408 is also operative to assign a transmission priority to one or more portions of the content that is to be transmitted and routed to the one or more client devices 102.

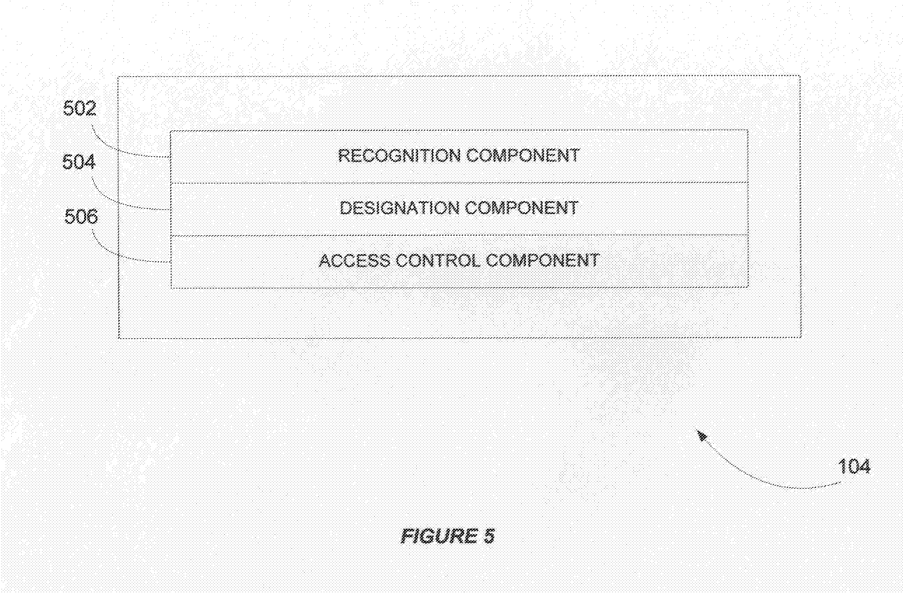

FIG. 5 illustrates an embodiment of the client module 104. Each client module 104 includes a recognition component 502, a designation component 504 and an access control component 506. The recognition component 502 is operative to receive at least one portion of content and to recognize a format and a transmission protocol of the content. The designation component is operative to receive a language specific content selection from a user for at least one portion of content that is to be executed by the access control component 506. The access control component 506 is operative to control access to resources on a client device 102 and to execute one or more portions of content on one or more of the client devices 102. In one embodiment, the access control component 506 is also operative to verify the compatibility of the received content and its format and transmission protocol for execution on the client devices 102. The client module 104 is also operative to manage variable rates for receiving and executing content based on a transmission priority established by a data processing server 108. Specifically, the recognition component 502 is operative to receive at least a portion of content based on a transmission priority established by the data processing component 108 and the access control component 506 is operative to execute received content based on a transmission priority of the content from one or more data processing servers 108.

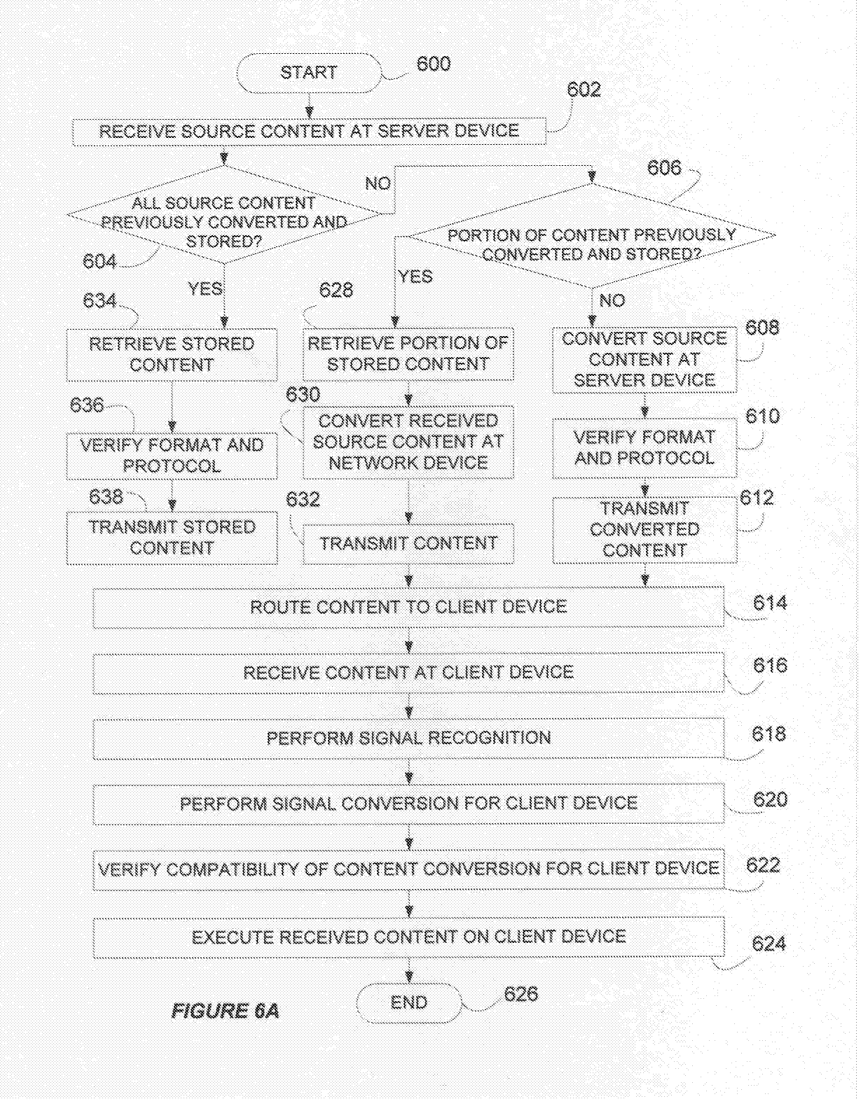

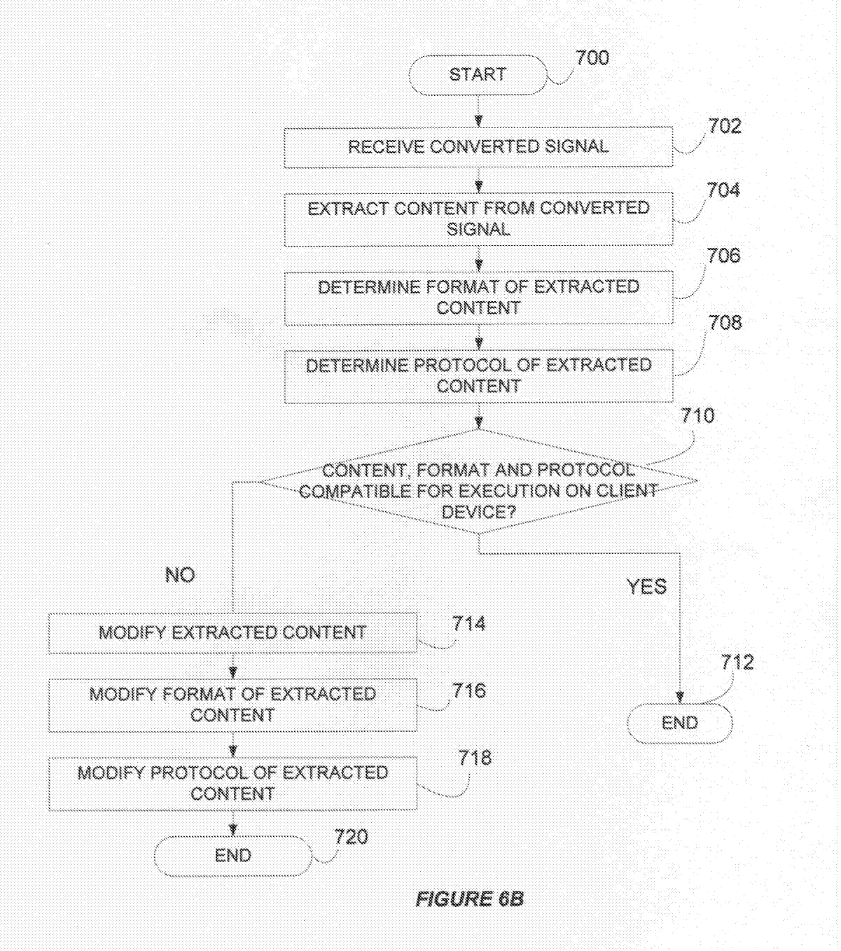

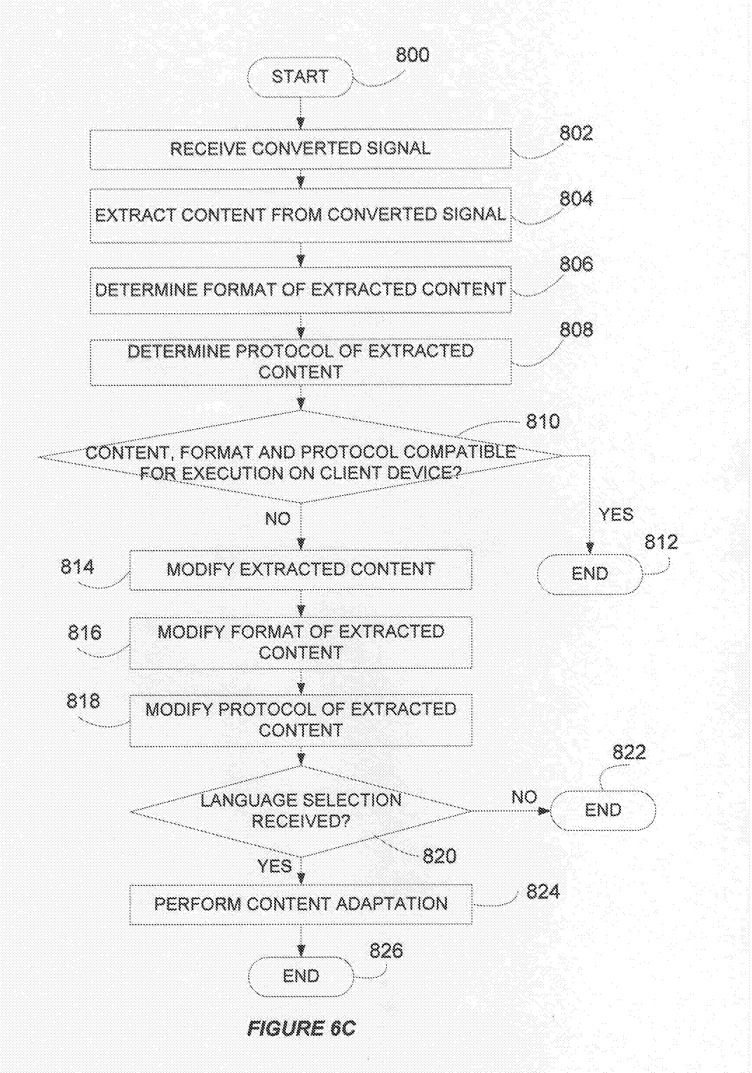

FIG. 6A provides a flowchart illustrating one embodiment of a method performed by this system. In this embodiment, the method begins at step 600 and commences with receiving source content at a data processing server 108 as shown at step 602. As indicated at step 604, all received content from content sources 112, 114 and 116 is checked to determine whether all or a portion of the content had previously been received, converted and stored in a memory 308 or a storage device 312 of a data processing server 108. If all of the received content had previously been converted and stored in a data processing server 108, all of the content will be retrieved, as shown at step 634, and the format and transmission protocol of that content will be verified for compatibility and execution on one or more of the client devices 102 (as shown at step 636) and then the content will be transmitted over the network 106, as shown at step 638.

Alternatively, if some of the received source content had not been previously received then a data processing server 108 will analyze the received content to determine whether a portion of the content had previously been converted and stored, as shown at step 606. If a portion had previously been converted and stored, then the portion that had previously been stored will be retrieved as shown at step 628 and the newly received content will be converted to the format, transmission protocol and signal resolution required for execution of the content on the target client devices 102, as shown at step 630. Afterwards, the combination of retrieved and converted content will be transmitted to one or more client devices 102, as shown at step 632. If none of the content had been previously received and stored in a data processing server 108, then the received source content will be converted on a data processing server 108, as shown at step 608 and the format and transmission protocol of the converted content will be verified for compatibility with one or more target client devices 102, as shown at step 610. After verification of compatibility, the converted content will be transmitted to the client devices 102, as shown at step 612.

In each case, regardless of whether the content was previously received in whole or in part, the transmitted content will be routed to one or more client devices 102 over the network 106, as shown at step 614. The content will be received at the intended client device 102, as shown at step 616 and a signal recognition process will be performed as shown at step 618 and if necessary, a conversion of the received signal will be performed on the client device 102, as shown at step 620. In one embodiment, the term “signal” is intended to represent a data transmission of a wireless information data signal. In an alternative embodiment, the term “signal” is intended to mean a data communication stream generated by a computing device that is comprised of one or more packets representing one or more portions of content. In this regard, the data communication stream is also an information data signal. In still another embodiment, all content sources 112, 114, 116 reside in a fully mapped, closed environment and all communications between the content sources 112, 114, 116 and client devices 102 are mapped by a routing application on the data processing servers 108. In this embodiment, a signal is not only a representation of a data transmission or a data communication stream, but is also used by the routing application on one or more data processing servers 108 to automatically determine the destination for and to automatically route a received signal from a content source 112, 114, 116 to one or more client devices 102.

As a representative example, image and video information may be transmitted in either a computer data communication signal through a wired communication channel or as a wireless information data signal over a wireless communication channel. Regardless of the channel over which such information may be transmitted, a process will be performed in each receiving client device 102 to analyze the resolution of the signal received (step 618) and the content contained within the signal (e.g., down-sampling a wireless signal and adjusting or converting the resolution of the received image and/or video information for proper display on a client device 102, etc.) to ensure that it can be executed and displayed on the client device 102. A process is performed to verify the compatibility of the received content for the client device, as shown at step 622, after receipt of the source content and the completion of a signal conversion (step 620). If the conversion is verified as being compatible, then the received content will be executed on the client device 102, as shown at step 624, and then the process will terminate as shown at step 626.

FIG. 6B illustrates an embodiment of a two-part process for validating and verifying compatibility of the converted content for a client device 102, which process was identified at step 622 in FIG. 6A. Steps 700-708 represent the validation process, while steps 710-720 represent the compatibility verification process. As shown in the present figure, the validation process commences at step 700 with the receipt of a converted signal (step 702). After receipt of the signal, content is extracted from the converted signal, as shown at step 704, and a format and a transmission protocol of the extracted content are determined, as shown at steps 706 and 708. The determination of transmission protocol will also identify whether the content received has been or is being transmitted to the client device 102 with a transmission priority.

After determining the transmission protocol of the extracted content, the compatibility verification process will be initiated by performing a comparison of the extracted content, format and protocol with the processing attributes of the client device 102. This comparison is performed to confirm whether the received content can be executed on the client device 102. Although the data processing servers 108 perform the conversions on content and associated format and transmission protocols that are intended to be compatible with attributes and computing capabilities of each of receiving client devices 102, the compatibility verification process that is performed locally on each client device 102 is performed as a supplemental means of determining compatibility of the received content, format and transmission protocol for the specific receiving client device 102. This approach is advantageous as one way of enhancing the reliability of the entire system and the conversion method it implements.

If the content, format and transmission protocol are verified as being compatible with the client device 102, then the compatibility verification process will terminate, as indicated at step 712. However, if the received content, format and transmission protocol are not compatible with the client device 102, then the extracted content will be modified to ensure that it will be compatible for execution on the client device 102, as shown at step 714. In one embodiment, the modification of the extracted content involves the analysis of packet sizes in a data stream for the extracted content and a comparison of these packet sizes with the queuing and data processing capabilities of the receiving client device 102. In addition to content modification, the compatibility process also includes a step for modifying the format of the extracted content (step 716) and a step for modifying the transmission protocol of the extracted content, shown at step 718. These modifications, when necessary, are performed on the client devices 102 to ensure that the content can be safely executed without consuming additional computing resources for content, format and protocol conversions on one or more data processing servers 108. After completion of any modification required to the transmission protocol for the content (step 718), the compatibility verification process will end, as shown at step 720.

In an alternative embodiment shown in FIG. 6C, the validation and compatibility verification process commences at step 800 with the receiving of a converted signal, shown at step 802. The content included in the signal will be extracted (step 804), and the format and transmission protocol of the extracted content will be determined, as shown at steps 806 and 808. The determination of transmission protocol will also identify whether the content received has been or is being transmitted to the client device 102 with a transmission priority. After determining the transmission protocol of the extracted content, the compatibility verification process will begin with a comparison of the extracted content, format and protocol with the processing capabilities of the client device 102. If the content, format and transmission protocol are compatible with processing capabilities of the client device 102, then the compatibility verification process will terminate, as indicated at step 812.

However, if the received content, format and transmission protocol are not compatible with the client device 102, then the extracted content will be modified to ensure that it will be compatible for execution on the client device 102, as shown at step 814. In an embodiment, the modification of the extracted content involves the analysis of packet sizes in a data stream for the extracted content and a comparison of these packet sizes with the queuing and data processing capabilities of the receiving client device 102. In addition to content modification, the compatibility process also includes modifying the format of the extracted content (step 816) and modifying the transmission protocol of the extracted content, shown at step 818. These modifications, when necessary, are performed on client devices 102 to ensure that the content can be safely executed without consuming additional computing resources for content, format and protocol conversions on one or more data processing servers 108.

After completion of any modification required to the transmission protocol for the content (step 818), the compatibility verification process will check an input of the client device 102 to determine whether a user has selected a preferred language for the rendering and display of the content on the client device 102, as shown at step 820. If no language selection is received, then the compatibility verification process will end, as shown at step 822. However, if a language selection is received, the information data signal providing the received content will be analyzed to determine if supplemental data has been transmitted with the content that can be used to enable the display of the received content in the language designated by the user on the client device 102. If supplemental data for the content is available in the received information data signal, then the received content will be displayed in the selected language. In one embodiment, supplemental data is included in the information data signal that enables received content to be displayed in a language specially designated by a user of a client device 102.

On the other hand, if the selected language is not available in the supplemental data from the received content signal, then a command will be issued by the client device 102 to one or more of the data processing servers 108 to have the content adapted for the user of the requesting client device 102. Upon receipt of this command, a data processing server 108 will perform a content adaptation process that will adapt the semantic content, the symbolic content, the grammatical content and the format and transmission protocol, as necessary, to the specific language or dialect requested by the user to ensure that the content will be received, executed and displayed successfully on the user's client device 102. The process of adapting content for a user's language preference is performed on a data processing server 108 and is shown at step 824. Upon placing the request for a content adaptation, the process will terminate (step 826) and the client device 102 will await receipt of a new converted signal in the language that was selected by the user.

Returning to FIG. 1, the content received by each data processing server 108 from the content sources 112, 114, 116 may be received over a wireless communication channel, a satellite communication channel, a broadcast communication channel or a wired communication channel. Content transmissions can be received by a data processing server 108 as a real-time transmission, a delayed broadcast transmission or a prerecorded transmission. The content received from each content source 112, 114, 116 can include audio information, video information, text information or multimedia information each of which includes semantic content, a defined transmission format and a specific transmission protocol that is determined by the content source 112, 114, 116. The conversion process performed on the data processing server 108 comprises translating the semantic content and converting the format and transmission protocol to ensure that the content can be executed on one or more of the intended client devices 102. The content can be converted in real-time with the receiving of the content from one or more content sources 112, 114, 116. In one embodiment, the real-time conversion of content is performed “dynamically” with the receiving of the content. Real-time dynamic conversion produces content that can be rendered and executed on the client devices 102 after real-time interpretation of the semantic content, format and transmission protocol. In an alternative embodiment, the real-time conversion is performed “live” with the receiving of the content. Real-time conversion produces an instantaneous conversion of the received content, including a conversion of its format and transmission protocol, for rendering and execution on the client devices 102. As a conversion is performed, if the content has not previously been stored in a data processing server 108, at least one copy of the converted content will be stored in a local data store such as memory 308 or storage device 312 on one or more data processing servers 108.

Each data processing server 108 is also capable of transmitting the converted content over a wireless communication network or a broadcast communication network, if such content had been received over a wired communication channel as a computer data communication. In one embodiment, the conversion of the content comprises converting a signal attribute of the received content for subsequent routing over a wireless communication network to one or more client devices 102. In this embodiment, each data processing server 108 can allocate a specific transmission frequency to a specific client device 102 for transmission of content on a wireless signal over a wireless communication network. Each of the data processing servers 108 can also deny or prevent transmission of content to one or more client devices 102 regardless of the type of communication network available. In an alternative embodiment, the conversion of the content comprises converting a signal attribute of the content for routing of the content over a broadcast communication network to one or more client devices 102. In still an alternative embodiment, the routing of content at step 614 occurs over a wired communication network. Each of the foregoing forms of routing are embodiments of the process performed at step 614 in FIG. 6A.

Client devices 102 can be consumer devices such as televisions, set-top boxes (including televisions coupled to set-top boxes), digital video disc players, desktop computers, laptop computers, personal digital assistants, cellular telephones, and palmtop computers. Each of these consumer devices are capable of receiving and executing one or more portions of content received from a data processing server 108 if that server has received content from a content source 112, 114, 116 and converted it for execution on one or more of client devices 102. In one embodiment, the routing of the content to a client device 102, as shown at step 614, includes a pre-processing step that applies a signal manipulation method to the content before it is transmitted over the network 106 to one or more client devices 102.

Frequency manipulation is one type of signal manipulation method applied in an embodiment. In an alternative embodiment, amplitude manipulation is applied as the signal manipulation method. Both of these methods increase the efficiency of the transmission and routing process for the content (step 614). In still another embodiment, the content to be transmitted is pre-processed prior to routing by applying a fractal compression method that can maximally compress the content for efficient transmission to one or more client devices 102. In another embodiment, a combination of both the signal manipulation method and the fractal compression method are applied to maximize content compression for one or all of the different types of information provided as content (e.g., text, audio, video, multimedia, etc.) and to enhance transmission efficiency for routing of the content to one or more client devices 102.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

1. A computer-implemented method for converting and routing content over a network, the method comprising:
receiving at least one portion of content over the network, the at least one portion of content having a format and a transmission protocol;
verifying whether the at least one portion of content was previously stored and converted for execution on one or more client devices;
converting the at least one portion of content on at least one server if it has not been previously stored and converted for execution on the one or more client devices;
retrieving the at least one portion of content on the at least one server if it has been previously stored and converted for execution on the one or more client devices;
routing the retrieved at least one portion of content and the converted at least one portion of content over the network to the one or more client devices; and
executing the retrieved at least one portion of content and the converted at least one portion of content on the one or more client devices.

2. The computer-implemented method of claim 1 wherein the content is comprised of audio information.

3. The computer-implemented method of claim 1 wherein the content is comprised of image information.

4. The computer-implemented method of claim 1 wherein the content is comprised of video information.

5. The computer-implemented method of claim 1 wherein the content is comprised of text information.

6. The computer-implemented method of claim 1 wherein the content is comprised of multimedia information.

7. The computer-implemented method of claim 1 wherein the format of the at least one portion of content is an analog format.

8. The computer-implemented method of claim 1 wherein the at least one portion of content is received on a wireless communication channel.

9. The computer-implemented method of claim 1 wherein the at least one portion of content is received on a satellite communication channel.

10. The computer-implemented method of claim 1 wherein the at least one portion of content is received on a broadcast communication channel.

11. The computer-implemented method of claim 1 wherein the at least one portion of content is received on a wired communication channel.

12. The computer-implemented method of claim 1 wherein the at least one portion of content is received in a real-time transmission.

13. The computer-implemented method of claim 1 wherein the at least one portion of content is received in a delayed broadcast transmission.

14. The computer-implemented method of claim 1 wherein the at least one portion of content received is received in a pre-recorded transmission.

15. The computer-implemented method of claim 2 wherein the audio information is comprised of semantic content and wherein the converting of the received at least one portion of content comprises translating the semantic content and converting the format and the transmission protocol.

16. The computer-implemented method of claim 4 wherein the video information is comprised of semantic content and wherein the converting of the received at least one portion of content comprises translating the semantic content and converting the format and the transmission protocol.

17. The computer-implemented method of claim 5 wherein the text information is comprised of semantic content and wherein the converting of the received at least one portion of content comprises translating the semantic content and converting the format and the transmission protocol.

18. The computer-implemented method of claim 6 wherein the multimedia information is comprised of semantic content and wherein the converting of the received at least one portion of content comprises translating the semantic content and converting the format and the transmission protocol.

19. The computer-implemented method according to claims 15, 16, 17 or 18 wherein the converting of the received at least one portion of content occurs in real-time with the receiving of the at least one portion of content.

20. The computer-implemented method of claim 19 wherein the converting of the at least one portion of content in real-time is performed dynamically as the at least one portion of content is received.

21. The computer-implemented method of claim 19 wherein the converting of the at least one portion of content in real-time is performed instantaneously as the at least one portion of content is received.

22. The computer-implemented method of claim 1 wherein a copy of the converted at least one portion of content is stored in a memory before the at least one portion of content is routed to the one or more client devices.

23. The computer-implemented method of claim 1 wherein the routing of the retrieved at least one portion of content and the received at least one portion of content comprises applying fractal compression to the retrieved content and the received content.

24. The computer-implemented method of claim 23 wherein the routing of the retrieved at least one portion of content and the received at least one portion of content further comprises applying a signal manipulation method to the received content and the retrieved content before their transmission over the network to the one or more client devices.

25. The computer-implemented method of claim 1 wherein each of the one or more client devices has a mapped destination in a closed networked environment that is automatically determined upon the receiving of the at least one portion of content, and wherein the routing of the retrieved content and the converted content to the mapped destination is performed automatically based on the determination of the mapped destination.

26. The computer-implemented method of claim 1 wherein the routing of the retrieved at least one portion of content and the received at least one portion of content occurs over a wireless communication network.

27. The computer-implemented method of claim 1 wherein the routing of the retrieved at least one portion of content and the received at least one portion of content occurs over a broadcast communication network.

28. The computer-implemented method of claim 1 wherein the routing of the retrieved at least one portion of content and the received at least one portion of content occurs over a wired communication network.

29. The computer-implemented method of claim 26 wherein converting the at least one portion of the received content further comprises converting a signal attribute of the received content for routing over the wireless communication network and for executing on the one or more client devices.

30. The computer-implemented method of claim 27 wherein converting the at least one portion of the received content further comprises converting a signal attribute of the received content for routing over the broadcast communication network and for executing on the one or more client devices.

31. The computer-implemented method of claim 1 wherein the one or more client devices includes at least one of a television, a set-top box, a digital video disk player, a desktop computer, a laptop computer, a personal digital assistant, a cellular telephone and a palmtop computer, each of which are enabled for executing the at least one portion of retrieved content and the at least one portion of converted content.

32. The computer-implemented method of claim 1 wherein the network is the Internet.

33. The computer-implemented method of claim 1 wherein the network is a virtual private network.

34. The computer-implemented method of claim 1 wherein the network is a satellite network.

35. The computer-implemented method of claim 1 wherein the network is a corporate intranet.

36. The computer-implemented method of claim 1 wherein the format of the at least one portion of content is a digital format.

37. The computer-implemented method of claim 1 wherein the network is comprised of a plurality of geographic regions, each region including one or more content sources and determined by at least one of:
a transmission traffic pattern from the one or more content sources;
a usage pattern of the one or more content sources; and
a pertinence factor indicating the pertinence of the at least one portion of content to a group of users of the one or more content sources that generated the at least one portion of content.

38. A computer-readable medium having a content conversion and distribution product stored thereon, the product operative to receive at least one portion of content, the product comprising:
an identification component operative to determine a format and a transmission protocol of the at least one portion of content;
a selector component operative to select a conversion for the at least one portion of content, the format and the transmission protocol;
a conversion component operative to convert the at least one portion of content, the format and the transmission protocol based on the conversion selected by the selector component; and
a transmission component operative to transmit over a network the converted at least one portion of content, the format and the transmission protocol to one or more client devices.

39. The computer-readable medium of claim 38 wherein the network is comprised of a plurality of geographic regions, each region including one or more content sources and determined by at least one of:
a transmission traffic pattern from the one or more content sources;
a usage pattern of the one or more content sources; and
a pertinence factor indicating the pertinence of the at least one portion of content to a group of users of the one or more content sources that generated the at least one portion of content.

40. The computer-readable medium of claim 38 further comprising a signal attribute component operative to convert the at least one portion of content for routing over at least one of a wireless communication network and a broadcast communication network.

41. The computer-readable medium of claim 38 further comprising a validation component operative to validate the conversion of the at least one portion of content, the format, and the transmission protocol for execution on one or more client devices.

42. The computer-readable medium of claim 38 wherein the at least one portion of content comprises a semantic content, a language-specific symbolic content and a language-specific grammar.

43. The computer-readable medium of claim 42 wherein the at least one portion of content is received in an information data signal, the information data signal delivered over at least one of a wired communication network, a wireless communication network and a broadcast communication network.

44. The computer-readable medium of claim 43 wherein the transmission component is further operative to automatically determine a destination for the information data signal from among the one or more client devices and to automatically route the information data signal to the destination.

45. The computer-readable medium of claim 43 wherein the selector component is operative to select the conversion based on at least one of the format, the transmission protocol, the semantic content, the language-specific symbolic content, a source signal resolution for the information data signal, a destination signal resolution for the one or more client devices, a source signal frequency for the information data signal, and a destination signal frequency for the one or more client devices.

46. The computer-readable medium of claim 38 wherein the selector component is further operative to designate a signal for the one or more client devices.

47. The computer-readable medium of claim 38 wherein the selector component is further operative to assign a signal to the one or more client devices.

48. The computer-readable medium of claim 40 wherein the signal attribute component is operative to convert the at least one portion of content using a signal manipulation method.

49. The computer-readable medium of claim 48 wherein the signal manipulation method comprises at least one of a frequency manipulation method and an amplitude manipulation method.

50. The computer-readable medium of claim 38 wherein the at least one portion of content is received in a live transmission.

51. The computer-readable medium of claim 38 wherein the at least one portion of content is received in a delayed broadcast transmission.

52. The computer-readable medium of claim 38 wherein the at least one portion of content received is received in a pre-recorded transmission.

53. The computer-readable medium according to claims 50, 51 or 52 wherein the conversion component is operative to convert the at least one portion of content in real-time with the receiving of the at least one portion of content.

54. The computer-readable medium of claim 53 wherein the conversion of the at least one portion of content in real-time is performed dynamically with the receiving of the at least one portion of content.

55. The computer-readable medium of claim 53 wherein the conversion of the at least one portion of content in real-time is performed instantaneously with the receiving of the at least one portion of content.

56. The computer-readable medium of claim 38 wherein the at least one portion of content is comprised of audio information.

57. The computer-readable medium of claim 38 wherein the at least one portion of content is comprised of image information.

58. The computer-readable medium of claim 38 wherein the at least one portion of content is comprised of video information.

59. The computer-readable medium of claim 38 wherein the at least one portion of content is comprised of text information.

60. The computer-readable medium of claim 38 wherein the at least one portion of content is comprised of multimedia information, the multimedia information including a plurality of audio information, image information, video information and text information.

61. The computer-readable medium of claim 38 wherein the format of the at least one portion of content is an analog format.

62. The computer-readable medium of claim 38 wherein the format of the at least one portion of content is a digital format.

63. The computer-readable medium of claim 38 wherein the conversion component is further operative to a store a copy of the conversion in a memory.

64. The computer-readable medium of claim 45 wherein the selector component is operative to retrieve the selected conversion of the at least one portion of content from a previously selected conversion stored in a memory.

65. The computer-readable medium of claim 38 wherein the network is the Internet.

66. The computer-readable medium of claim 38 wherein the network is a virtual private network.

67. The computer-readable medium of claim 38 wherein the network is a satellite network.

68. The computer-readable medium of claim 38 wherein the network is a corporate intranet.

69. The computer-readable medium of claim 38 wherein the transmission component assigns a transmission priority to the at least one portion of content.

70. An apparatus for converting and distributing content, the content having at least one portion, the apparatus comprising:
a memory;
a processor coupled to the memory; and
a content conversion and distribution product stored in the memory, the product operative to:
receive the at least one portion of content having a format and a transmission protocol;
verify whether the at least one portion of content was previously stored and converted for execution on one or more client devices;
convert the at least one portion of content if it has not been previously stored and converted for execution on one or more client devices;
retrieve the at least one portion of content from the memory if it has been previously stored and converted for execution on one or more client devices; and
route the converted at least one portion of content over a network to one or more client devices.

71. The apparatus of claim 70 wherein the network is comprised of a plurality of geographic regions, each region including one or more content sources and determined by at least one of:
a transmission traffic pattern from the one or more content sources;
a usage pattern of the one or more content sources; and
a pertinence factor indicating the pertinence of the content to a group of users of the one or more content sources that generated the content.

72. The apparatus of claim 70 wherein the content is comprised of audio information.

73. The apparatus of claim 70 wherein the content is comprised of image information.

74. The apparatus of claim 70 wherein the content is comprised of video information.

75. The apparatus of claim 70 wherein the content is comprised of text information.

76. The apparatus of claim 70 wherein the content is comprised of multimedia information.

77. The apparatus of claim 70 wherein the format of the at least one portion of content is an analog format.

78. The apparatus of claim 70 wherein the format of the at least one portion of content is a digital format.

79. The apparatus of claim 70 wherein the at least one portion of content is received on a wireless communication channel.

80. The apparatus of claim 70 wherein the at least one portion of content is received on a satellite communication channel.

81. The apparatus of claim 70 wherein the at least one portion of content is received on a broadcast communication channel.

82. The apparatus of claim 70 wherein the at least one portion of content is received on a wired communication channel.

83. The apparatus of claim 70 wherein the at least one portion of content is received in a real-time transmission.

84. The apparatus of claim 70 wherein the at least one portion of content is received in a delayed broadcast transmission.

85. The apparatus of claim 70 wherein the at least one portion of content received is received in a pre-recorded transmission.

86. The apparatus of claim 72 wherein the audio information is comprised of semantic content and wherein the product is further operative to translate the semantic content and to convert the format and the transmission protocol.

87. The apparatus of claim 74 wherein the video information is comprised of semantic content and wherein the product is further operative to translate the semantic content and to convert the format and the transmission protocol.

88. The apparatus of claim 75 wherein the text information is comprised of semantic content and wherein the product is further operative to translate the semantic content and to convert the format and the transmission protocol.

89. The apparatus of claim 76 wherein the multimedia information is comprised of semantic content and wherein the product is further operative to translate the semantic content and to convert the format and the transmission protocol.

90. The apparatus according to claims 86, 87, 88 or 89 wherein the product is further operative to convert the received at least one portion of content in real-time with the receiving of the at least one portion of content.

91. The apparatus of claim 90 wherein the real-time conversion of the at least one portion of content is performed dynamically with the receiving of the at least one portion of content.

92. The apparatus of claim 90 wherein the real-time conversion of the at least one portion of content is performed instantaneously with the receiving of the at least one portion of content.

93. The apparatus of claim 70 wherein the product is further operative to store the converted at least one portion of content in the memory before the at least one portion of content is routed to the one or more client devices.

94. The apparatus of claim 70 wherein the product is operative to route the retrieved at least one portion of content and the received at least one portion of content by applying fractal compression to the retrieved content and the received content.

95. The apparatus of claim 94 wherein the product is operative to route the retrieved at least one portion of content and the received at least one portion of content by applying a signal manipulation method to the received content and the retrieved content before their transmission over the network to the one or more client devices.

96. The apparatus of claim 70 wherein the product is operative to route the retrieved at least one portion of content and the received at least one portion of content over a wireless communication network.

97. The apparatus of claim 70 wherein the product is operative to route the retrieved at least one portion of content and the received at least one portion of content over a broadcast communication network.

98. The apparatus of claim 70 wherein the product is operative to route the retrieved at least one portion of content and the received at least one portion of content over a wired communication network.

99. The apparatus of claim 70 wherein the product is further operative to automatically determine a destination from among the one or more client devices for the at least one portion of content and to automatically route the at least one portion of content to the destination.

100. The apparatus of claim 96 wherein the product is operative to convert the at least one portion of the received content by converting a signal attribute of the received content for routing over the wireless communication network and for executing on the one or more client devices.

101. The apparatus of claim 97 wherein the product is operative to convert the at least one portion of the received content by converting a signal attribute of the received content for routing over the broadcast communication network and for executing on the one or more client devices.

102. The apparatus of claim 70 wherein the one or more client devices includes at least one of a television, a set-top box, a digital video disc player, a desktop computer, a laptop computer, a personal digital assistant, a cellular telephone and a palmtop computer, each of which are enabled for executing the at least one portion of retrieved content and the at least one portion of converted content.

103. The apparatus of claim 70 wherein the network is the Internet.

104. The apparatus of claim 70 wherein the network is a virtual private network.

105. The apparatus of claim 70 wherein the network is a satellite network.

106. The apparatus of claim 70 wherein the network is a corporate intranet.

107. An apparatus for content execution, the apparatus comprising:
a memory;
a processor coupled to the memory, the processor having at least one operational mode; and
a content execution product stored in the memory, the product operative to:
receive at least one portion of content, the at least one portion of content having a format and a transmission protocol;
recognize the format and the transmission protocol of the received at least one portion of content;
verify compatibility of the received at least one portion of content, the format and the transmission protocol with the at least one operational mode of the processor; and
execute the received at least one portion of content on the processor if verified to be compatible with the at least one operational mode of the processor.

108. The apparatus of claim 107 wherein the content is comprised of audio information.

109. The apparatus of claim 107 wherein the content is comprised of image information.

110. The apparatus of claim 107 wherein the content is comprised of video information.

111. The apparatus of claim 107 wherein the content is comprised of text information.

112. The apparatus of claim 107 wherein the content is comprised of multimedia information.

113. The apparatus of claim 107 wherein the format of the at least one portion of content is an analog format.

114. The apparatus of claim 107 wherein the format of the at least one portion of content is a digital format.

115. The apparatus of claim 107 wherein the at least one portion of content is received on a wireless communication channel.

116. The apparatus of claim 107 wherein the at least one portion of content is received on a satellite communication channel.

117. The apparatus of claim 107 wherein the at least one portion of content is received on a broadcast communication channel.

118. The apparatus of claim 107 wherein the at least one portion of content is received on a wired communication channel.

119. The apparatus of claim 107 wherein the at least one portion of content is received in a real-time transmission.

120. The apparatus of claim 107 wherein the at least one portion of content is received in a delayed broadcast transmission.

121. The apparatus of claim 107 wherein the at least one portion of content received is received in a pre-recorded transmission.

122. A computer-readable medium having a content execution product stored thereon, the product comprising:
a recognition component operative to receive at least one portion of content and to recognize a format and a transmission protocol of the at least one portion of content;
an access control component operative to control and execute the at least one portion of content; and
a designation component operative to receive a language-specific content selection for the at least one portion of content to be executed by the access control component.

123. The computer-readable medium of claim 122 wherein the content is comprised of audio information.

124. The computer-readable medium of claim 122 wherein the content is comprised of image information.

125. The computer-readable medium of claim 122 wherein the content is comprised of video information.

126. The computer-readable medium of claim 122 wherein the content is comprised of text information.

127. The computer-readable medium of claim 122 wherein the content is comprised of multimedia information.

128. The computer-readable medium of claim 122 wherein the format of the at least one portion of content is an analog format.

129. The computer-readable medium of claim 122 wherein the format of the at least one portion of content is a digital format.

130. The computer-readable medium of claim 122 wherein the at least one portion of content is received on a wireless communication channel.

131. The computer-readable medium of claim 122 wherein the at least one portion of content is received on a satellite communication channel.

132. The computer-readable medium of claim 122 wherein the at least one portion of content is received on a broadcast communication channel.

133. The computer-readable medium of claim 122 wherein the at least one portion of content is received on a wired communication channel.

134. The computer-readable medium of claim 122 wherein the at least one portion of content is received in a real-time transmission.

135. The computer-readable medium of claim 122 wherein the at least one portion of content is received in a delayed broadcast transmission.

136. The computer-readable medium of claim 122 wherein the at least one portion of content received is received in a pre-recorded transmission.

137. The computer-readable medium of claim 122 wherein the access control component is further operative to execute the at least one portion of content on one or more devices.

138. The computer-readable medium of claim 122 wherein the recognition component is further operative to receive the at least one portion of content based on a transmission priority.

139. The computer-readable medium of claim 138 wherein the access control component is further operative to execute the at least one portion of content based on the transmission priority.

140. The computer-readable medium of claim 122 wherein the access control component is further operative to verify compatibility of the at least one portion of content, the format and the transmission protocol with one or more client devices before executing the at least one portion of content.
